(19) United States
(12) Patent Application Publication
(10) Pub. No.: US 2022/0001546 A1
(43) Pub. Date: Jan. 6, 2022

(54) ROBOT

(71) Applicant: LG ELECTRONICS INC., Seoul (KR)

(72) Inventors: Seyoung WOO, Seoul (KR); Junghyun LEE, Seoul (KR)

(21) Appl. No.: 16/763,332

(22) PCT Filed: Jun. 14, 2019
(86) PCT No.: PCT/KR2019/007224

§ 371 Date: May 12, 2020

(51) Int. Cl. B25J 11/00; B25J 9/00; B25J 9/10

(52) U.S. Cl. CPC B25J 11/00; B25J 9/106; B25J 9/0009

(57) ABSTRACT

A robot according to an embodiment of the present invention includes: a main body; a moving rotatably mounted on the main body; a tail protruding outward from the moving housing; a first actuator mounted on the main body, disposed below the moving housing, and configured to allow the moving housing to rotate; a moving link disposed inside the moving housing, the moving link being connected to the tail; and a second actuator disposed inside the moving housing, the second actuator being configured to allow the moving link to rotate.

### TECHNICAL FIELD

The present invention relates to a robot, and more particularly, to a robot including at least one actuator for driving a head.

### BACKGROUND ART

Robots have been developed for industrial use in order to be part of factory automation. In recent years, fields of application of the robots have been expanded, and thus, robots that are used in everyday life as well as medical robots and aerospace robots are being developed.

Particularly, pet robots modeled from a shape of a pet like a dog may provide emotional satisfaction to the user. Such a pet robot may operate similar to a real pet and output a sound. Since the pet robot does not need to feed or clean up waste thereof, the pet robot may reduce the hassle and burden of busy modern people while providing emotional satisfaction just like a real pet.

### DISCLOSURE OF THE INVENTION

### Technical Problem

An object of the present invention is to provide a robot that is capable of implementing movement of buttocks and a tail.

Another object of the present invention is to provide a robot that is compact and capable of smoothly operating without an interference between components.

### Technical Solution

In a robot according to an embodiment of the present invention, a first actuator mounted on a main body may allow a moving housing to rotate, and a second actuator disposed in the moving housing may allow a moving link connected to a tail to rotate. In this case, since the moving link and the tail rotate together with the moving housing, the tail may operate in two degrees of freedom.

In more detail, a robot according to an embodiment of the present invention includes: a main body; a moving housing rotatably mounted on the main body; a tail protruding outward from the moving housing; a first actuator mounted on the main body, disposed below the moving housing, and configured to allow the moving housing to rotate; a moving link disposed inside the moving housing, the moving link being connected to the tail; and a second actuator disposed inside the moving housing, the second actuator being configured to allow the moving link to rotate.

A rotation shaft of the first actuator and a rotation shaft of the second actuator may be perpendicular to each other.

An outer surface of the moving housing may include a sphere surface having a predetermined curvature.

A housing mounting part configured to surround a portion of an outer surface of the moving housing may be disposed on the main body.

A separation prevention part bent or protruding outward from an edge of the outer surface of the moving housing and disposed inside the housing mounting part may be disposed on the moving housing.

The moving housing may include: a hosing base connected to the first actuator and having an opened top surface; and a housing cap configured to cover an upper side of the housing base.

The moving link may include: a main link having an arc shape corresponding to that of an inner surface of the moving housing; and a connection link configured to connect the second actuator to the main link.

A tail connection part protruding from the main link to the tail and connected to the tail may be disposed on the main link.

An actuator coupling part which protrudes inward from the inner surface of the moving housing and to which the second actuator is coupled may be disposed on the moving housing, and the actuator coupling part and the connection link may be disposed at sides opposite to each other with respect to the second actuator.

The main link may overlap the second actuator in a front and rear direction.

A slit configured to restrict a rotation range of the tail may be defined in the moving housing, and a slit cover configured to cover the slit may be disposed between the moving housing and the main link.

The inner surface of the moving housing may include a guide surface on which the main link and the slit cover are disposed and which has a predetermined curvature.

A guide rib configured to guide movement of the main link and the slit cover may be disposed on the inner surface of the moving housing.

A limiter configured to limit a movement range of the slit cover may be disposed on the inner surface of the moving housing.

The slit cover may have an arc shape that is longer than the main link.

An inner slit facing the slit and having an arc shape that is shorter than the slit may be defined in the slit cover.

The robot may further include: an interface disposed inside the moving housing; and a fixed link which is fixed to the main body and to which the interface is coupled.

A plurality of through-holes facing the interface may be defined in the moving housing.

The fixed link may include: a fixed part disposed outside the moving housing, the fixed part being fixed to the main body; an interface coupling part which is disposed inside the moving housing and to which the interface is coupled; and a connection part configured to connect the fixed part to the interface coupling part.

The interface may be disposed above the second actuator, and the moving link may include: a main link having an arc shape corresponding to that of an inner surface of the moving housing; and a connection link configured to connect the second actuator to a lower end of the main link, the connection link being disposed below the interface.

### Advantageous Effects

According to a preferred embodiment of the present invention, the first actuator may allow the moving housing to rotate with respect to the main body to implement the buttock movement of the pet.

Also, the second actuator may allow the tail to rotate with respect to the moving housing to implement the tail movement of the pet.

Also, since the second actuator and the moving link are disposed inside the moving housing and rotate together with the moving housing, the tail part of the robot may be compact.

Also, since the rotation axis of the first actuator and the rotation axis of the second actuator are perpendicular to each other, the tail may operate in the two degrees of freedom.

Also, the outer surface of the moving housing may include the sphere surface having the predetermined curvature. Thus, the moving housing and the tail may rotate smoothly in different directions.

Also, the housing mounting part surrounding a portion of the outer surface of the moving housing may be disposed on the main body. Therefore, only a portion of the moving housing may be seen from the outside, and thus, the outer appearance of the robot may be improved in design.

Also, the separation prevention part disposed inside the housing mounting part may be disposed on the edge of the outer surface of the moving housing. Thus, the moving housing may smoothly rotate without being separated from the housing mounting part.

Also, the moving housing may include the housing base having the opened upper surface and a housing cap covering the housing base from the upper side. Thus, the arrangement of the components such as the second actuator in the moving housing may be smoothly performed.

Also, the moving link may include the main link having the arc shape corresponding to the inner surface of the moving housing. Thus, the main link may rotate along the inner surface of the moving housing and may not interfere with other components disposed inside the moving housing.

Also, the tail connection part connected to the tail may be disposed on the main link. Thus, the main link and the tail may be easily connected to each other.

Also, the actuator coupling part fixing the second actuator to the moving housing may be disposed at the side that is opposite to the connection link connecting the second actuator to the main link. Thus, the connection link and the actuator coupling part may not interfere with each other when the moving link rotates.

Also, the main link may overlap the second actuator in the front and rear direction. That is, while the main link is sufficiently long, the main link may rotate without interfering with the second actuator.

Also, the slit that limits the rotation range of the tail may be defined in the moving housing. Thus, the tail may rotate vertically along the slit.

Also, the slit cover covering the slit may be provided between the moving housing and the main link. Thus, the inside of the moving housing may be prevented from being excessively exposed through the slit.

Also, the inner surface of the moving housing may include the guide surface on which the main link and the slit cover are disposed and which has the predetermined curvature. Also, the guide rib guiding the movement of the main link and the slit cover may be disposed on the inner surface of the housing. Thus, the main link and the slit cover may be guided by the guide ribs and may rotate smoothly along the guide surface.

Also, the limiter limiting the movement range of slit cover may be disposed on the inner surface of the housing. Thus, the slit cover may be prevented from completely separated between the inner surface of the moving housing and the outer surface of the main link.

Also, the slit cover may have the arc shape that is longer than the main link. Thus, the slit cover may smoothly rotate between the inner surface of the moving housing and the outer surface of the main link and may reliably cover the slit.

Also, the inner slit having the arc shape that is shorter than the slit may be defined in the slit cover. Thus, the moving link and the tail may be smoothly connected to each other through the inner slit, and the tail may rotate along the inner slit.

Also, the interface fixed to the main body by the fixed link may be disposed inside the moving housing. Thus, the inner space of the moving housing may be utilized efficiently, and the fixed link and the interface may be fixed even when the moving housing rotates.

Also, the plurality of through-holes facing the interface may be defined in the moving housing. Thus, the user may smoothly interact with the interface through the sound passing through the through-holes.

Also, the fixed link may include the fixed part disposed outside the moving housing, the interface coupling part disposed inside the moving housing, and the connection part connecting the fixed part to the interface coupling part. Thus, the interface may be fixed to the main body while being disposed inside the moving housing.

Also, the moving link may include the connection link connecting the second actuator to the lower end of the main link and disposed below the interface. Thus, the moving link may smoothly rotate upward without the interference between the connection link and the interface.

### BRIEF DESCRIPTION OF THE DRAWINGS

FIG. 1 is a side view according to an embodiment of the present invention.

FIG. 2 is a rear perspective view according to an embodiment of the present invention.

FIG. 3 is a cross-sectional view illustrating the inside of a robot according to an embodiment of the present invention.

FIG. 4 is an enlarged cross-sectional view of a tail part of FIG. 3.

FIG. 5 is a perspective view of the tail part according to an embodiment of the present invention.

FIG. 6 is a perspective view of the tail part of FIG. 5 when viewed in a different direction.

FIG. 7 is a perspective view of the tail part of FIG. 5 when viewed in a different direction.

FIGS. 8A and 8B are views illustrating an operation in which a tail rotates horizontally according to an embodiment of the present invention.

FIGS. 9A and 9B are views illustrating an operation in which the tail rotates vertically according to an embodiment of the present invention.

### MODE FOR CARRYING OUT THE INVENTION

Hereinafter, detailed embodiments of the present invention will be described in detail with reference to the accompanying drawings.

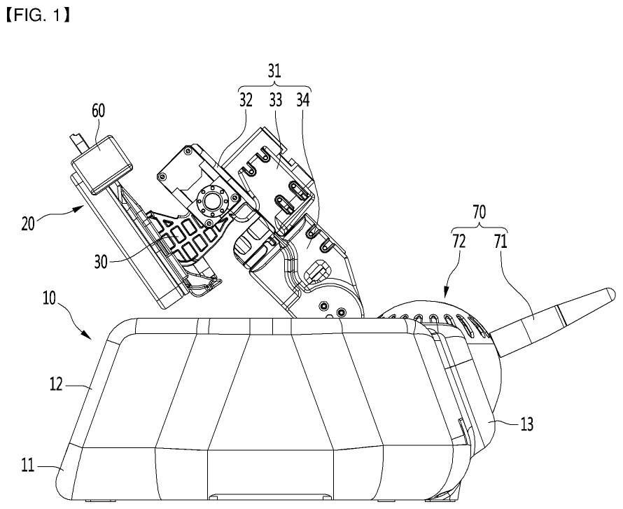

FIG. 1 is a side view of a robot according to an embodiment of the present invention.

A robot according to an embodiment of the present invention may include a main body 10, a head part 20, a neck body 30, and a movable assembly 31.

The main body 10 may have an inner space. For example, a controller (not shown) controlling an overall operation of the robot and a battery (not shown) supplying power to the robot may be provided in the inner space.

In more detail, the main body 10 may include a base 11 and a body cover 12 disposed above the base 11 to cover the base 11.

The base 11 may define a bottom surface of the main body 10. A movable wheel (not shown) for traveling of the robot may be provided on the base 11.

The body cover 12 may be coupled to the base 11 at an upper side of the base 11. The inner space of the main body 10 may be defined between the base 11 and the body cover 12.

The head part 20 may correspond to a head of the robot. The head part 20 may be provided with a display displaying various pieces of information, photographs, or videos, which are represented by letters or pictures. The display may be provided on a front surface of the head part 20.

The head part 20 may be disposed above the main body 10. However, the present invention is not limited thereto, and the head part 20 may be disposed at an upper front side of the main body 10. Also, the head part 20 may be spaced apart from the main body 10.

An ear 60 may be provided on the head part 20. The ear 60 may be provided in a left and right pair. The ear 60 may be rotatably connected to the head part 20. Thus, the ear 60 may alternately move with respect to the head part 20 so as to be similar to an actual pet.

The neck body 30 may be coupled to the head part 20. In more detail, the neck body 30 may be coupled to a rear surface of the head part 20. The neck body 30 may move together with the head part 20.

The movable assembly 31 may allow the heat part 20 to move with respect to the main body 10. It is preferable that the movable assembly 31 allows the head part 20 to move to three or more degrees of freedom.

The movable assembly 31 may connect the neck body 30 to the main body 10. The movable assembly 31 may be disposed above the main body 10.

The movable assembly 31 may include a plurality of movable bodies 32, 33, and 34. One movable body may be rotatably connected to the other movable body that is adjacent to the one movable body. A rotation axis of the one movable body is preferably perpendicular to a rotation axis of the other movable body.

For example, the movable assembly 31 may include first to third movable bodies 32, 33, and 34.

The neck body 30 may be rotatably connected to the first movable body 32. The first movable body 32 may be rotatably connected to the second movable body 33. The second movable body 33 may be rotatably connected to the third movable body 34. The third movable body 34 may be rotatably connected to the main body 10.

In this case, the head part 20 may operate in four degrees of freedom with respect to the main body 10 and may realize various operations similar to a head of the actual pet.

On the other hand, the robot according to an embodiment of the present invention may include a tail part 70.

The tail part 70 may be connected to a rear portion of the main body 10.

The tail part 70 may include a tail 71 and a moving housing 72 to which the tail 71 is connected.

The tail 71 may correspond to a tail of the pet, and the moving housing 72 may correspond to a buttock of the pet.

The tail 71 may be connected to the moving housing 72. The tail 71 may protrude to the outside of the moving housing 72. The moving housing 72 may rotate with respect to the main body 10, and the tail 71 may rotate with respect to the moving housing 72. That is, the tail 71 may move in two degrees of freedom with respect to the main body 10.

The moving housing 72 may be rotatably mounted to the rear portion of the main body 10. A housing mounting part 13 on which the moving housing 72 is mounted may be disposed at the rear portion of the main body 10.

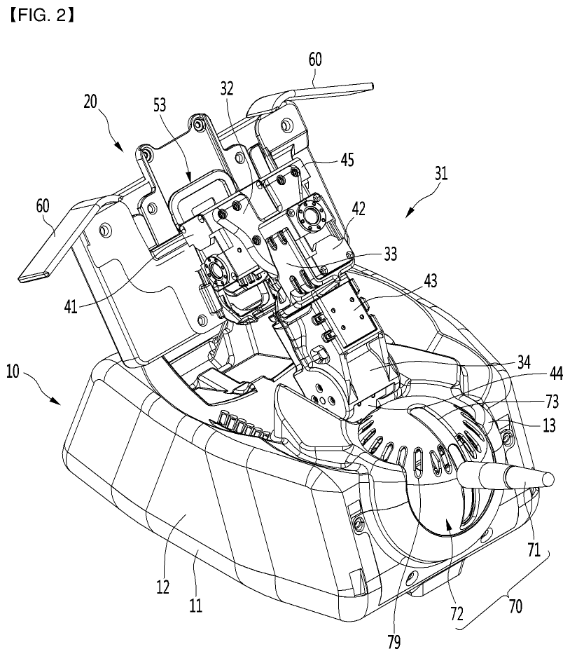

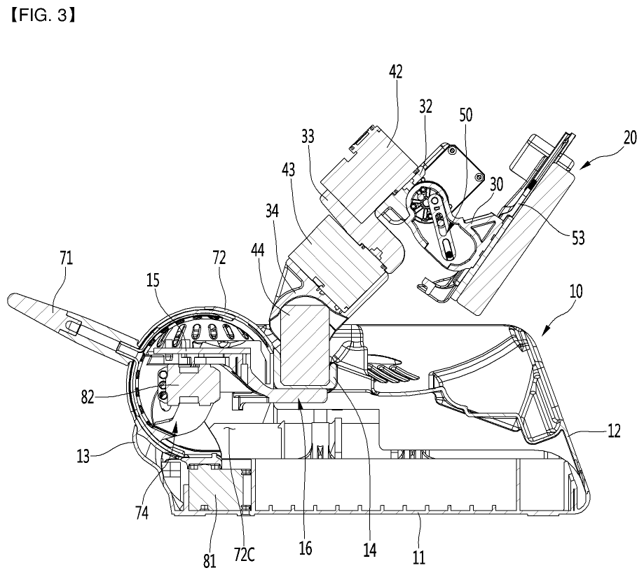

FIG. 2 is a rear perspective view according to an embodiment of the present invention, and FIG. 3 is a cross-sectional view illustrating the inside of the robot according to an embodiment of the present invention.

The robot according to this embodiment includes a main actuator 41 that allows the neck body 30 to rotate, and moving actuators 42, 43, and 44 that allow the movable bodies 32, 33, and 34 to rotate, and a sub actuator 45 that provides rotational power of the ear 60.

Each of the main actuator 41, the moving actuators 42, 43, and 44 and the sub actuator 45 may be a motor. Each of the main actuator 41 and the moving actuators 42, 43, and 44 may be a bidirectional rotary motor. On the other hand, the sub actuator 45 may be a one-way rotary motor or a two-way rotary motor.

The main actuator 41 may be fixed to the first movable body 32.

The main actuator 41 may be connected to the neck body 30 and may allow the neck body 30 to rotate with respect to the first movable body 32.

A rotation axis X1 of the main actuator 41 may be lengthily defined horizontally. Thus, the main actuator 41 may tilt the neck body 30 vertically. Since the neck body 30 is coupled to the head part 20, the head part 20 may be tilted together with the neck body 30.

The number of moving actuators 42, 43, and 44 may correspond to the number of movable bodies 32, 33, and 34 provided in the movable assembly 31. For example, the plurality of moving actuators may include first to third moving actuators 42, 43, and 44.

The first moving actuator 42 may be fixed to the second movable body 33.

The first moving actuator 42 may be connected to the first movable body 32 and may allow the first movable body 32 to rotate with respect to the second movable body 33. Since the main actuator 41 is fixed to the first movable body 32, the main actuator 41 may rotate together with the first movable body 32.

A rotation axis of the first moving actuator 42 may be perpendicular to a rotation axis of the main actuator 41.

The second moving actuator 43 may be fixed to the third movable body 34.

The second moving actuator 43 may be connected to the second movable body 33 and may allow the second movable body 33 to rotate with respect to the third movable body 34. Since the first moving actuator 42 is fixed to the second movable body 33, the first moving actuator 42 may rotate together with the third movable body 32.

A rotation axis of the second moving actuator 43 may be perpendicular to the rotation axis of the main actuator 41 and the rotation axis of the first moving actuator 42.

The third moving actuator 44 may be fixed to the body part 10.

The third moving actuator 44 may be connected to the third movable body 34 and may allow the third movable body 34 to rotate with respect to the main body 10.

A rotation axis X4 of the third moving actuator 44 may be parallel to the rotation axis X1 of the main actuator 41, and the rotation axis X2 of the first moving actuator 42 may be perpendicular to the rotation axis X3 of the second moving actuator 43. That is, the rotation axis X4 of the third moving actuator 44 may be lengthily defined horizontally

Thus, the third moving actuator 44 may tilt the third movable body 34 vertically. Since the second moving actuator 43 is fixed to the third movable body 34, the second moving actuator 43 may be tilted together with the third movable body 34.

An output of each of the actuators may preferably increase in order of the main actuator 41, the first moving actuator 42, the second moving actuator 43, and the third moving actuator 44. This is done because a moving load increases from the head part 20 to the main body 10.

For example, a load by which the head part and the neck body 30 are driven may be applied to the main actuator 41, which is closest to the head part 20, among the plurality of actuators 41, 42, 43, and 44. On the other hand, a load by which the head part 20, the neck body 30, the main actuator 41, the first movable body 32, the first moving actuator 42, the second movable body 33, the second moving actuator 43, and the third movable body 34 are driven may be applied to the third moving actuator 44, which is closest to the main body 10, among the plurality of actuators 41, 42, 43, and 44.

The sub actuator 45 may be connected to the crank device 50 to allow the moving frame 53 to move vertically, thereby providing power for allowing the ear 60 to alternately moving with respect to the head part 20.

The moving frame 53 may be connected to a rear surface of the head part 20 so as to be movable. The ear 60 may be rotatably connected to the head part 20, and the moving frame 53 may press the ear 60 to allow the ear 60 to rotate.

The crank device 50 may be mounted to the neck body 30. The crank device 50 may convert the rotational force of the sub actuator 45 into the vertical movement force of the moving frame 53.

The sub actuator 45 may be fixed to the first movable body 32, like the main actuator 41.

The sub actuator 45 may be disposed at a side opposite to the main actuator 41 with respect to the neck body 30. Both sides of the neck body 30 may contact the main actuator 41 and the sub actuator 45, respectively. The neck body 30 may be restricted in the horizontal direction between the main actuator 41 and the sub actuator 45.

The main actuator 41 and the sub actuator 45 may be disposed symmetrically with respect to the neck body 30. Thus, a movable balance, i.e., a dynamic characteristic of the movable assembly 31 may be improved.

A rotation axis of the sub actuator 45 and the rotation axis of the main actuator 41 may be parallel to each other and may be preferably disposed in a straight line.

The housing mounting part 13 of the main body 10 may protrude to a rear side of the main body 10 to correspond to the outer surface of the moving housing 72. The housing mounting part 13 may cover a portion of the outer surface of the moving housing 72. An opening that is opened backward and upward may be defined in the housing mounting part 13, and the moving housing 72 may be seen to the outside of the main body 10 through the opening.

The moving housing 72 may have an approximately shell shape. In more detail, the outer surface of the moving housing 72 may include a sphere surface having a predetermined curvature. The sphere surface may be a portion that is seen from the outside of the main body 10. That is, the sphere surface may be seen to the outside through the opening of the housing mounting part 13.

The moving housing 72 may be rotatably mounted to the main body, more specifically, the housing mount 13. The moving housing 72 may rotate horizontally with respect to a virtual vertical axis.

A slit 73 that limits a rotation range of the tail 71 may be defined in the moving housing 72. The slit 73 may be defined in the sphere surface of the moving housing 72 and be seen from the outside of the main body 10. The slit 73 may have an arc shape that is lengthily defined vertically. The tail 71 may rotate about the moving housing 72 along the slit 73.

The robot according to an embodiment of the present invention may include a first actuator 81 that allow the moving housing 72 to rotate and a second actuator 82 that allows the tail 71 to rotate. Each of the first actuator 81 and the second actuator 82 may be a motor capable of bidirectionally rotating.

A rotation axis of the first actuator 81 and a rotation axis of the second actuator 82 may be perpendicular to each other. In more detail, the rotation axis of the first actuator 81 may be vertical, and the rotation axis of the second actuator 82 may be horizontal. The first actuator 81 may allow the moving housing 72 horizontally, and the second actuator 82 may allow the tail 71 vertically.

The first actuator 81 may be mounted to the main body 10 and be disposed below the moving housing 72. In more detail, the first actuator 81 may be mounted at a rear portion of the base 11.

The second actuator 82 may be built in the moving housing 72. The second actuator 82 may rotate horizontally together with the moving housing 72.

The second actuator 82 may allow the moving link 74 connected to the tail 71 to rotate. The moving link 74 may be disposed inside the moving housing 72 to connect the second actuator 82 to the tail 71.

The robot according to an embodiment of the present invention may further include an interface 15 disposed inside the moving housing 72 and a fixed link 16 that fixes the interface 15.

The interface 15 may include a substrate. Also, the interface 15 may include at least one of a speaker or a microphone. Thus, the moving housing 72 may be provided with a plurality of through-holes 79 through which the sound of the speaker is outputted, or an external sound is inputted into the microphone.

The interface 15 may be disposed above the second actuator 82. The interface 15 may not interfere with the moving link 74 which rotates by the second actuator 82.

The fixed link 16 may be fixed to the main body 10 and be coupled to the interface 15. That is, the interface 15 and the fixed link 16 may be fixed so as not to move regardless of the rotation of the tail 71 and the moving housing 72.

A link coupling part to which the fixed link 16 is coupled may be disposed on the main body 10. The link coupling part 14 may be disposed outside the moving housing 72, more particularly, in front of the moving housing 72.

In more detail, the link coupling part 14 may be recessed downward from a top surface of the main body cover 12. The fixed link 16 may be coupled to a bottom surface of the link coupling part 14. Also, the third moving actuator 44 described above may be mounted on a top surface of the link coupling part 14. Also, an upper rear end of the moving housing 72 may contact or be adjacent to a rear surface of the link coupling part 14.

An opening 72C through which the fixed link 16 passes may be defined in the moving housing 72. The opening 72C may be opened toward a front side or a front lower side and may communicate with the inside of the main body 10. A portion of an upper portion of the opening 72C may be covered by the rear surface of the link coupling part 14.

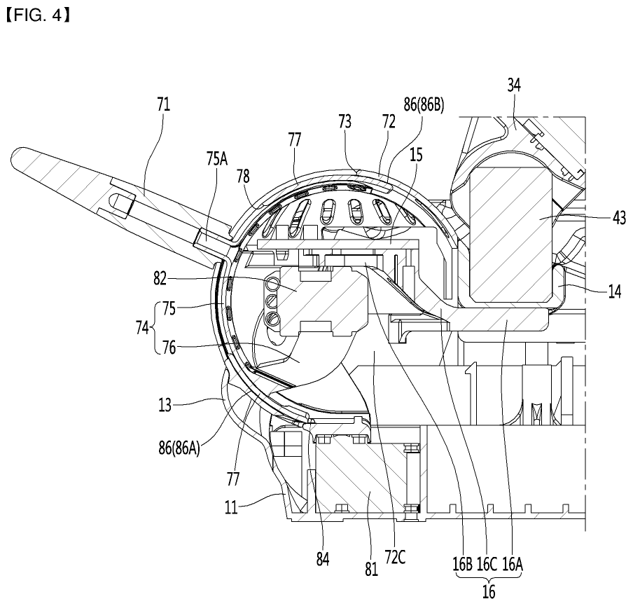

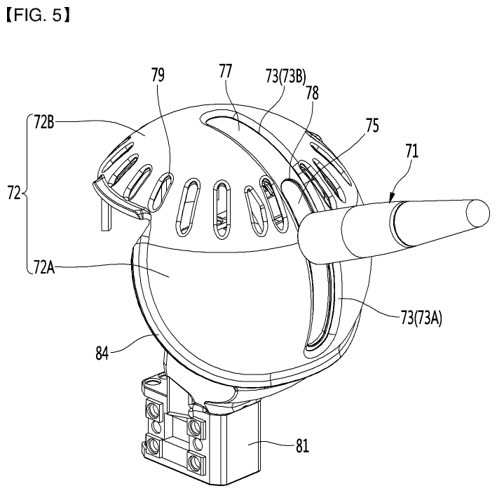

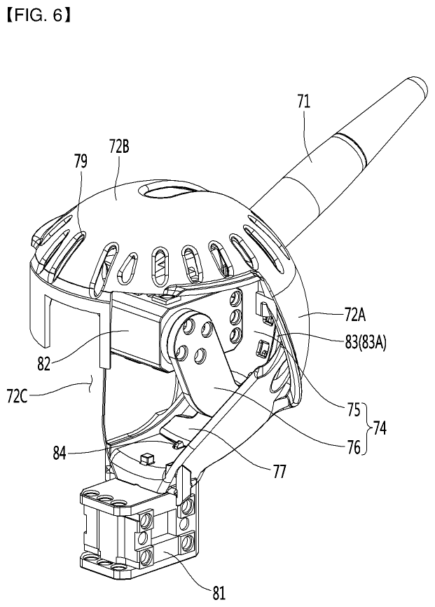

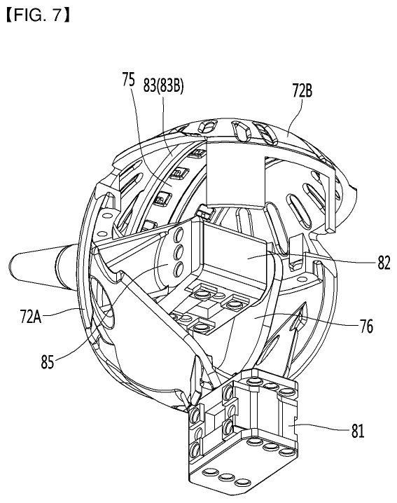

FIG. 4 is an enlarged cross-sectional view of the tail part of FIG. 3, FIG. 5 is a perspective view of the tail part according to an embodiment of the present invention, FIG. 6 is a perspective view of the tail part of FIG. 5 when viewed in a different direction, and FIG. 7 is a perspective view of the tail part of FIG. 5 when viewed in a different direction.

The moving housing 72 may include a housing base 72A connected to the first actuator 81 and having an opened top surface and a housing cap 72B covering the housing base 72A from the upper side.

The housing base 72A and the housing cap 72B may be separably coupled to each other. Thus, other components such as the second actuator 82 and the moving link 74 may be easily mounted in the moving housing 72.

An outer surfaces of each of the housing base 72A and the housing cap 72B may have a sphere surface. The sphere surface of the housing base 72A may face an approximate rear side, and the sphere surface of the housing cap 72B may face an approximate upper side. The sphere surface of each of the housing base 72A and the housing cap 72B may be continuous to each other.

Also, the slit 73 defined in the moving housing 72 may be defined in the sphere surface of the moving housing 72.

The slit 73 may include a lower slit 73A defined in the housing base 72A and an upper slit 73B defined in the housing cap 72B. The housing base 72A and the housing cap 72B may be coupled to each other, and the lower slit 73A and the upper slit 73B may communicate with each other.

The slit 73 may be defined in a central portion of the moving housing 72 with respect to the horizontal direction.

In more detail, the lower slit 73A may be defined in a central portion of the housing base 72A with respect to the horizontal direction, and the upper slit 73B may be defined in the central portion of the housing cap 72B with respect to the horizontal direction.

The lower slit 73A may include a lower end of the slit 73, and the upper slit 73B may include an upper end of the slit 73.

A separation prevention part 80A that is bent or protrudes outward from the edge of the outer surface of the moving housing 72. The separation prevention part 84 may be disposed on an edge of the sphere surface of the moving housing 72.

The separation prevention part 84 may have an arc shape having a predetermined curvature.

The separation prevention part 84 may be disposed inside the housing mounting part 13. The separation prevention part 84 may be hooked with an inner edge of the housing mounting part 13 to prevent the moving housing 72 from being separated from the housing mounting part 13.

The separation prevention part 84 disposed on the housing base 72A may prevent the moving housing 72 from being separated backward from the housing mounting part 13, and the separation prevention part 84 disposed on the housing cap 72B may prevent the moving housing 72 from being separated upward from the housing mounting part 13.

The moving link 74 may transmit rotational force of the second actuator 82 to the tail 81. The moving link 74 may be disposed in the moving housing 72 to connect the second actuator 82 to the tail 71.

In more detail, the moving link 74 may include an arc-shaped main link 75 and a connection link 76 connecting the second actuator 82 to the main link 75.

The main link 75 may have an arc shape that is lengthily provided vertically. The main link 75 may be lengthily disposed in a circumferential direction of the moving housing 72.

The main link 75 may have an arc shape corresponding to the inner surface of the moving housing 72.

The main link 75 may overlap the second actuator 82 and the interface 15 in the front and rear direction. A portion of the main link 75 may be disposed above the second actuator 82 and the interface 15, and the other portion may be disposed below the second actuator 82 and the interface 15.

A tail connection part 75A connected to the tail 71 may be disposed on the main link 75. The tail connection part 75A may protrude from the main link 75 toward the tail 71. That is, the tail 71 may protrude in a radially outward direction of the moving housing 72.

The tail connection part 75A may be connected to the tail 71 through an inner slit 78 defined in a slit cover 77 to be described later and the slit 73 defined in the moving housing 72. An insertion part into which the tail connection part 75A is inserted may be defined in the tail 71.

It is preferable that the connection link 76 is integrated with the main link 75, but is not limited thereto.

The connection link 76 may be lengthily disposed in a radial direction of the moving housing 72.

The connection link 76 may be connected to the lower end of the main link 75. In more detail, the connection link 76 may be connected to a lateral edge of the lower end of the main link 75. Thus, the connection link 76 may rotate only below the interface 15 and may not interfere with the interface 15.

The slit cover 77 covering the slit 73 may be provided between the main link 75 and the moving housing 72. In more detail, the slit cover 77 may be disposed between the outer surface of the main link 75 and the inner surface of the moving housing 72.

The slit cover 77 may cover the slit 73 from the inside.

Like the main link 75, the slit cover 77 may have an arc shape corresponding to the inner surface of the moving housing 72. The slit cover 77 may have a length greater than that of the main link 75. Like the main link 75, the slit cover 77 may rotate vertically along the inner surface of the inner housing 72.

The inner slit 78 communicating with the slit 73 may be defined in the slit cover 77. The inner slit 78 may face the slit 73. Like the slit 73, the inner slit 78 may have an arc shape that is lengthily disposed vertically. The inner slit 78 may have a length that is less than that of the slit 73.

The tail connection part 75A may be connected to the tail 71 through the inner slit 78 and the slit 73. Thus, the tail 71 may rotate along the inner slit 78.

The inner slit 78 may be covered by the main link 75. In more detail, the main link 75 may cover the inner slit 78 from the inside. Thus, the inside of the moving housing 72 may be prevented from being excessively exposed through the inner slit 78.

The slit cover 77 may rotate between a first position at which a lower end of the inner slit 78 matches or is adjacent to a lower end of the slit 73 and a second position at which an upper end of the inner slit 78 matches or is adjacent to an upper end of the slit 73.

When the tail 71 rotates downward while the slit cover 77 is disposed at the first position, the slit cover 77 may not rotate, and the tail 71 may rotate along the inner slit 78.

When the tail 71 rotates upward while the slit cover 77 is disposed at the first position, the slit cover 77 may not rotate until the tail 71 or the tail connection part 75A contacts an upper end of the inner slit 78, and the tail 71 may rotate along the inner slit 78.

When the tail 71 rotates upward while the slit cover 77 is disposed at the first position, the tail 71 or the tail connection part 75A may contact the upper end of the inner slit 78 to push the slit cover 77 upward, and the slit cover 77 may rotate upward along the inner surface of the moving housing 72. The tail 71 may rotate up to the upper end of the slit 73 along the slit 73. In this case, the slit cover 77 may rotate up to the second position.

When the tail 71 rotates downward while the slit cover 77 is disposed at the second position, the tail 71 or the tail connection part 75A may rotate downward while contacting the upper end of the inner slit 78, and the slit cover 77 may rotate downward along the inner surface of the moving housing 72. After the slit cover 77 rotates up to the first position, the tail 71 or the tail connection part 75A may be spaced apart from the upper end of the inner slit 78 and rotate downward along the inner slit 78.

The slit cover 77 may not interfere with the rotation of the tail 71 while preventing the inside of the moving housing 72 from being excessively exposed through the slit 73 of the moving housing 72.

The inner surface of the moving housing 72 may include an arc-shaped guide surface 86 on which the main link 75 and the slit cover 77 are disposed and which has a predetermined curvature. The guide surface 86 may be disposed at the central portion of the moving housing 72 with respect to the horizontal direction. The slit 73 may pass through the guide surface 86.

The guide surface 86 may have a length greater than that of each of the main link 75 and the slit cover 77. The main link 75 and the slit cover 77 may rotate along the guide surface 86.

The guide surface 86 may include a lower guide surface 86A disposed inside the housing base 72A and an upper guide surface 86B disposed inside the housing cap 72B. The lower guide surface 86A and the upper guide surface 86B may be connected to each other so as to be continued to each other.

Also, a guide rib 83 that guides the movement of the main link 75 and the slit cover 77 may be disposed on the inner surface of the moving housing 72.

The guide rib 83 may be disposed on each of both sides of the guide surface 86. That is, the guide surface 86 may refer to an area of the inner surface of the moving housing 72 between the pair of guide ribs 83 which are spaced apart from each other in the horizontal direction.

The guide rib 83 may protrude from the inner surface of the moving housing 72. Each of the guide ribs 83 may have an arc shape. The main link 75 and the slit cover 77 may rotate vertically between the pair of guide ribs 83 spaced apart from each other in the horizontal direction.

The guide rib 83 may include a lower guide rib 83A disposed on each of both sides of the lower guide surface 86A and an upper guide rib 83B disposed on each of both sides of the upper guide surface 86B. The lower guide rib 83A and the upper guide rib 83B may be connected to each other so as to be continued to each other. The lower guide rib 83A may be disposed on the inner surface of the housing base 72A, and upper guide rib 83B may be disposed on the inner surface of the housing cap 72B.

Also, a limiter 84 that limits the movement range of the slit cover 77 may be disposed on the inner surface of the moving housing 72. In more detail, the limiter 84 may protrude inward from the guide surface 86.

For example, as illustrated in FIG. 4, the limiter 84 may be disposed on the lower guide surface 86A and may not be disposed on the upper guide surface 86B. In this case, the slit cover 77 may rotate downward up to the first position at which the lower end of the slit cover 77 contacts the limiter 84 and rotate upward up to the second position at which the upper end of the slit cover 77 contacts the rear surface of the link coupling part 14.

However, the present invention is not limited thereto. For example, the limiter 84 may be disposed on each of the lower guide surface 86A and the upper guide surface 86B. In this case, the slit cover 77 may rotate downward up to the first position at which the lower end of the slit cover 77 contacts the limiter disposed on the lower guide surface 86A and may rotate upward up to the second position at which the upper end of the slit cover 77 contacts the limiter disposed on the upper guide surface 86B.

The actuator coupling part 85 to which the second actuator 82 is coupled may be disposed on the moving housing 72. The actuator coupling part 85 may protrude inward from the inner surface of the moving housing 72. The actuator coupling part 85 may be provided eccentrical to one side of the moving housing 72 with respect to the horizontal direction.

The actuator coupling part 85 may be coupled to one side of the second actuator 82, and the connection link 76 may be connected to the other side of the second actuator 82. That is, the actuator coupling part 85 and the connection link 76 may be disposed at sides that are opposite to each other with respect to the second actuator 82. Thus, the connection link 76 may smoothly rotate vertically without interfering with the actuator coupling part 85.

The through-holes 79 may be defined in the housing cap 72B. The plurality of through-holes 79 may be spaced apart from each other in the circumferential direction of the housing cap 72B. Each of the through-holes 79 may be an arc-shaped long hole that is lengthily defined vertically along the outer surface of the housing cap 72B.

Each of the through-holes 79 may face the interface 15 disposed horizontally inside the moving housing 72. The interface 15 is preferably disposed inside the housing cap 72B. The interface 15 may be disposed above the second actuator 82, the actuator coupling part 85, and the connection link 76.

The interface 15 may be supported by the fixed link 16 and be fixed regardless of the rotation of the moving housing 72 and the tail 71.

The fixed link 16 may include a fixed part 16A fixed to the main body 10, an interface coupling part 16B disposed inside the moving housing 72, and a connection part 16C connecting the fixed part 16A to the interface coupling part 16B.

The fixed part 16A may be coupled and fixed to the link coupling part 14. In more detail, the fixed part 16A may be coupled to a bottom surface of the link coupling part 14. The fixed part 16A may be disposed outside the moving housing 72.

The interface 15 may be coupled to the interface coupling part 16B. In more detail, the interface coupling part 16B may be coupled to a lower portion of the interface 15. The interface coupling part 16B may be disposed inside the moving housing 72. The interface coupling part 16B may be disposed above the second actuator 82, the actuator coupling part 85, and the connection link 76.

The interface coupling part 16B may be disposed behind the rear surface of the link coupling part 14. Thus, the interface coupling part 16B may be disposed at a height that is higher than that of the fixed part 16A with respect to the bottom surface of the main body 10, i.e., the base 11.

The connection part 16C may pass through the opening 72C of the moving housing 72 to connect the fixed part 16A to the interface coupling part 16B. The connection part 16C may be inclined in a direction in which the height of the connection part 16C increases backward.

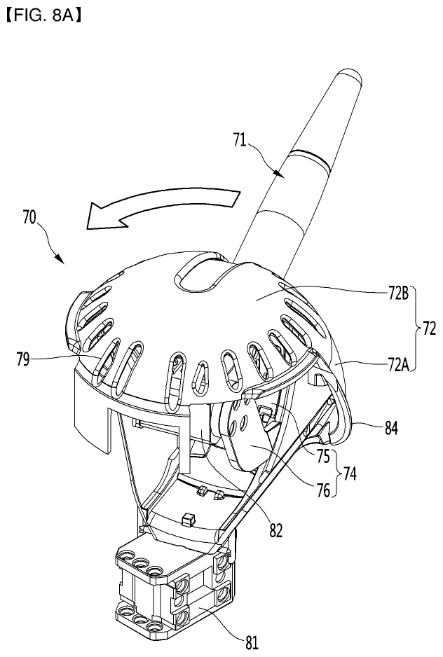

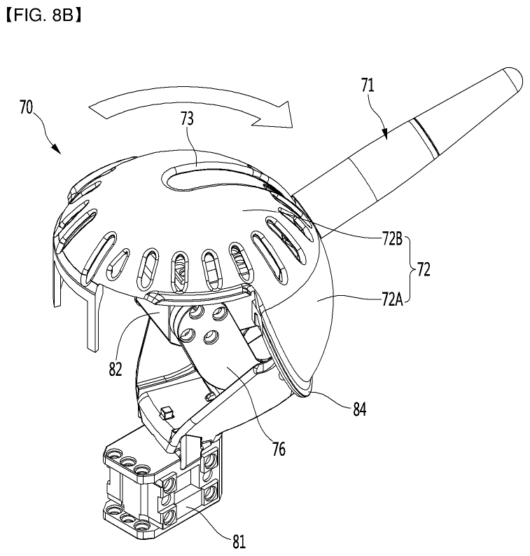

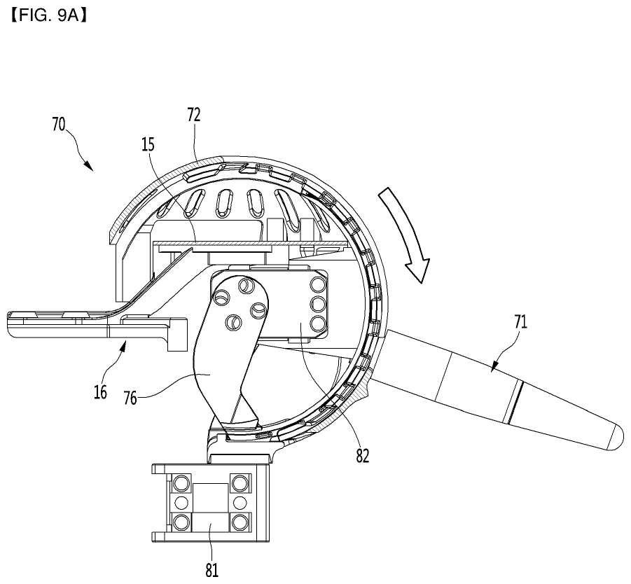

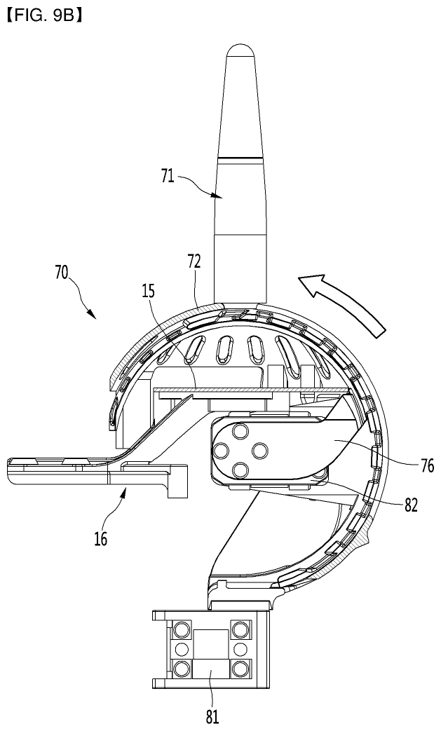

FIGS. 8A and 8B are views illustrating an operation in which the tail rotates horizontally according to an embodiment of the present invention, and FIGS. 9A and 9B are views illustrating an operation in which the tail rotates vertically according to an embodiment of the present invention.

Hereinafter, an effect of the tail part 70 will be described.

The first actuator 81 may allow the moving housing 72 connected to the first actuator 81 to rotate horizontally. Thus, the tail 71 may rotate horizontally together with the moving housing 72. Thus, an operation similar to that in which the pet horizontally shakes the buttocks and the tail thereof may be implemented.

Also, the second actuator 82, the moving link 74, and the slit cover 77 may rotate horizontally together with the moving housing 72 and the tail 71. Thus, the vertical rotation of the tail 71 may be performed independently with respect to the horizontal rotation of the tail 71.

The second actuator 82 may allow the moving link 74 connected to the second actuator 82 to rotate vertically, and the tail may rotate vertically together with the moving link 74. The moving link 74 may rotate vertically until the connection link 76 provided on the moving link 74 is adjacent to the bottom surface of the interface 15.

The above-disclosed subject matter is to be considered illustrative, and not restrictive, and the appended claims are intended to cover all such modifications, enhancements, and other embodiments, which fall within the true spirit and scope of the present disclosure.

Thus, the embodiment of the present disclosure is to be considered illustrative, and not restrictive, and the technical spirit of the present disclosure is not limited to the foregoing embodiment.

Therefore, the scope of the present disclosure is defined not by the detailed description of the invention but by the appended claims, and all differences within the scope will be construed as being included in the present disclosure.

1. A robot comprising:
a main body;
a moving housing rotatably mounted on the main body;
a tail protruding outward from the moving housing;
a first actuator mounted on the main body, disposed below the moving housing, and configured to allow the moving housing to rotate;
a moving link disposed inside the moving housing, the moving link being connected to the tail; and
a second actuator disposed inside the moving housing, the second actuator being configured to allow the moving link to rotate.

2. The robot according to claim 1, wherein a rotation shaft of the first actuator and a rotation shaft of the second actuator are perpendicular to each other.

3. The robot according to claim 1, wherein an outer surface of the moving housing comprises a sphere surface having a predetermined curvature.

4. The robot according to claim 1, wherein a housing mounting part configured to surround a portion of an outer surface of the moving housing is disposed on the main body.

5. The robot according to claim 4, wherein a separation prevention part bent or protruding outward from an edge of the outer surface of the moving housing and disposed inside the housing mounting part is disposed on the moving housing.

6. The robot according to claim 1, wherein the moving housing comprises:
a hosing base connected to the first actuator and having an opened top surface; and
a housing cap configured to cover an upper side of the housing base.

7. The robot according to claim 1, wherein the moving link comprises:
a main link having an arc shape corresponding to that of an inner surface of the moving housing; and
a connection link configured to connect the second actuator to the main link.

8. The robot according to claim 7, wherein a tail connection part protruding from the main link to the tail and connected to the tail is disposed on the main link.

9. The robot according to claim 7, wherein an actuator coupling part which protrudes inward from the inner surface of the moving housing and to which the second actuator is coupled is disposed on the moving housing, and
the actuator coupling part and the connection link are disposed at sides opposite to each other with respect to the second actuator.

10. The robot according to claim 7, wherein the main link overlaps the second actuator in a front and rear direction.

11. The robot according to claim 7, wherein a slit configured to restrict a rotation range of the tail is defined in the moving housing, and
a slit cover configured to cover the slit is disposed between the moving housing and the main link.

12. The robot according to claim 11, wherein the inner surface of the moving housing comprises a guide surface on which the main link and the slit cover are disposed and which has a predetermined curvature.

13. The robot according to claim 11, wherein a guide rib configured to guide movement of the main link and the slit cover is disposed on the inner surface of the moving housing.

14. The robot according to claim 11, wherein a limiter configured to limit a movement range of the slit cover is disposed on the inner surface of the moving housing.

15. The robot according to claim 11, wherein the slit cover has an arc shape that is longer than the main link.

16. The robot according to claim 11, wherein an inner slit facing the slit and having an arc shape that is shorter than the slit is defined in the slit cover.

17. The robot according to claim 1, further comprising:
an interface disposed inside the moving housing; and
a fixed link which is fixed to the main body and to which the interface is coupled.

18. The robot according to claim 17, wherein a plurality of through-holes facing the interface are defined in the moving housing.

19. The robot according to claim 17, wherein the fixed link comprises:
a fixed part disposed outside the moving housing, the fixed part being fixed to the main body;
an interface coupling part which is disposed inside the moving housing and to which the interface is coupled; and
a connection part configured to connect the fixed part to the interface coupling part.

20. The robot according to claim 17, wherein the interface is disposed above the second actuator, and
the moving link comprises:
a main link having an arc shape corresponding to that of an inner surface of the moving housing; and
a connection link configured to connect the second actuator to a lower end of the main link, the connection link being disposed below the interface.
